(19) United States
(12) Patent Application Publication
(10) Pub. No.: US 2007/0116389 A1
(43) Pub. Date: May 24, 2007

(54) Roller bearing device for bicycles

(76) Inventor: Chia-Wei Lin, Tan-Zi Hsiang (TW)

Correspondence Address: CHARLES E. BAXLEY, ESQ., 90 JOHN STREET, THIRD FLOOR, NEW YORK, NY, 10038, US

(21) Appl. No.: 11/271,669

(22) Filed: Nov. 10, 2005

(51) Int. Cl. F16C 33/00

(52) U.S. Cl. 384/16

(57) ABSTRACT

A bearing device for bicycles includes a first race having a first inclined surface and an annular engaging recess defmed in an inner periphery thereof. A support ring has a second inclined surface defined in an outer periphery thereof A roller set has a plurality of rollers which are located at an angle relative to a horizontal plane. The roller set is located between the first race and the support ring. The rollers are in contact with the first and second inclined surfaces. A second race includes a horizontal flange and a vertical flange which is engaged with the annular engaging recess and a noise absorbing material is coated to the second race to absorb noise.

### FIELD OF THE INVENTION

The present invention relates to a roller bearing device for bicycles and the bearing device generates less noise and prevents foreign objects from entering the bearing device.

### BACKGROUND OF THE INVENTION

A conventional bearing device for bicycles is connected to each of two ends of the head tube of the bicycle frame so that the handlebar stem and the steerer tube respectively extend through the two bearing devices and are rotatable relative to the head tube. However, the conventional bearing devices each include many parts which are small and easily to lost. Besides, it takes a lot of time to assemble the bearing devices. When installing the bearing devices to the bicycle frames, the assemblers often install the bearing device in wrong direction because the conventional bearing devices look very similar in two ends. Furthermore, foreign objects such as sands easily enter into the bearing devices and affect the operation of the bearing devices.

The present invention intends to provide a bearing device with rollers and the first race has an inclined outer periphery so that the assemblers easily identify the orientation when installing the bearing devices to the bicycle frames.

Furthermore, the bearing device has a race with noise absorbing material which absorbs noise when the bearing device is in.operation status.

### SUMMARY OF THE INVENTION

The present invention relates to a bearing device for bicycles and the bearing device comprises a first race having a first portion and a second portion which is integrally connected to the first portion. The first portion has a first inclined surface defined in an inner periphery thereof and an annular engaging recess is defined in an inner periphery of the second portion. A support ring has a second inclined surface defined in an outer periphery thereof. A roller set has a plurality of rollers rotatably connected with a retaining frame and the rollers are located at an angle relative to a horizontal plane. The roller set is located between the first race and the support ring. The rollers are in contact with the first and second inclined surfaces. A second race has an L-shaped cross section and includes a horizontal flange and a vertical flange which is engaged with the annular engaging recess. A noise absorbing material is coated on an outer periphery of each of the horizontal flange and the vertical flange of the second race.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bearing device of the present invention;

FIG. 2 is a perspective view, partly removed to show the bearing device of the present invention;

FIG. 3 is a cross sectional view of the bearing device of the present invention;

FIG. 4 is a cross sectional view to show that the bearing device is connected with another head tube, and FIG. 5 is a cross sectional view to show that the bearing device is connected with yet another head tube.

### DETAILED DESCRIPTION OF THE PREFERRED EMBODIMENT

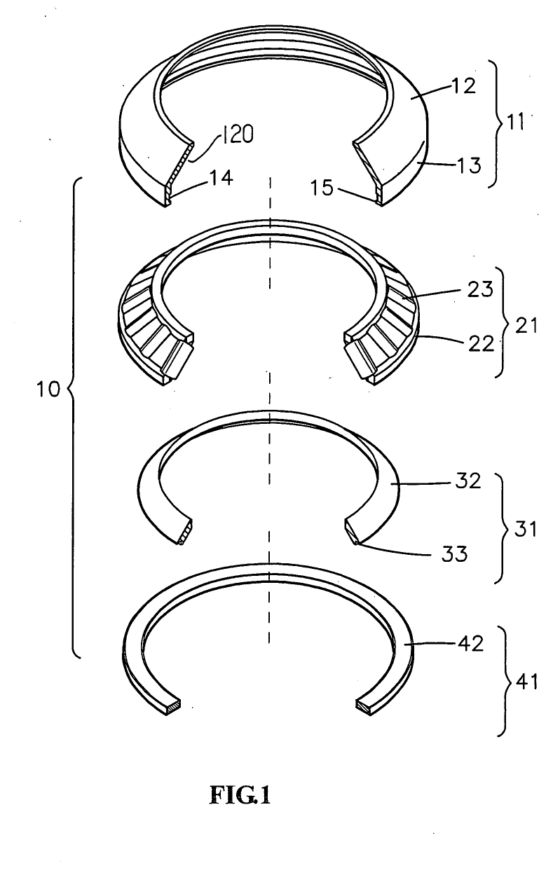

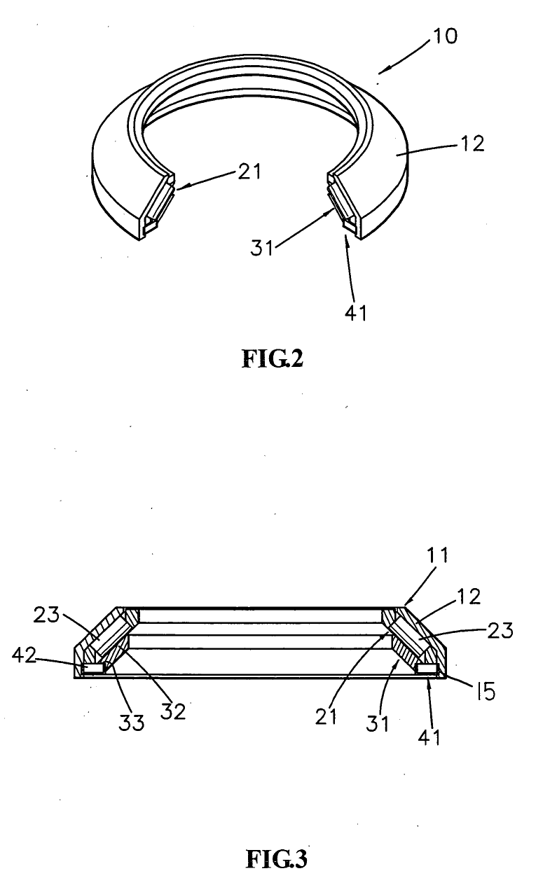

Referring to FIGS. 1 to 3, the bearing device 10 for bicycles of the present invention comprises a first race 11 having a first portion 12 and a second portion 13 which is integrally connected to the first portion 12. The first portion 12 has a first inclined surface 120 defined in an inner periphery thereof and an annular engaging recess 14 is defined in an inner periphery of the second portion 13. The first portion 12 has an inclined outer periphery and an annular lip 15 extends inward from a lower end of the second portion 13.

A support ring 31 has a second inclined surface 32 defined in an outer periphery thereof and the support ring 31 located in a space enclosed by the first race 11. The support ring 31 includes an annular notch 33 defined in an inner periphery thereof.

A roller set 21 has a plurality of rollers 23 rotatably connected with a retaining frame 22 and the rollers 23 are located at an angle relative to a horizontal plane. The roller set 21 is located between the first race 11 and the support ring 31. The rollers 23 are in contact with the first and second inclined surfaces 120, 32.

A second race 41 has an L-shaped cross section and includes a horizontal flange and a vertical flange which is engaged with the annular engaging recess 14. The annular lip 15 of the first race 11 is engaged with an underside of the horizontal flange of the second race 41 so as to well position the second race 41. An inner periphery of the horizontal flange of the second race 41 is engaged with the annular notch 33. A noise absorbing material 42 is coated on an outer periphery of each of the horizontal flange and the vertical flange of the second race 41.

The second race 41 prevents foreign objects such as. sands or water from entering the gaps between the rollers 23 so that the bearing device 10 of the present invention can be used for longer period of time. The noise absorbing material 42 can absorb the noise due to impact between the metal parts such as the first and second races 11 and 41.

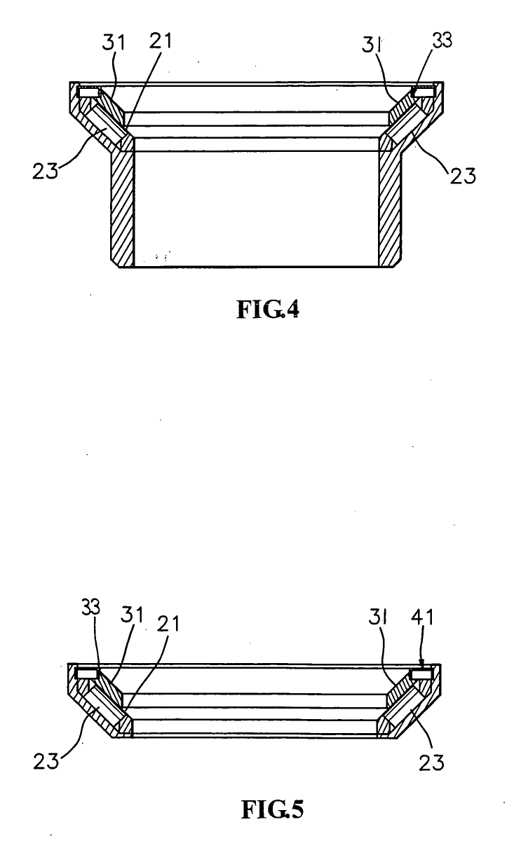

FIGS. 4 and 5 show that the bearing device of the present invention is connected with two different head tubes respectively.

While we have shown and described the embodiment in accordance with the present invention, it should be clear to those skilled in the art that further embodiments may be made without departing from the scope of the present invention.

What is claimed is:

1. A bearing device for bicycles, comprising:
a first race having a first portion and a second portion which is integrally connected to the first portion, the first portion having a first inclined surface defined in an inner periphery thereof, an annular engaging recess defined in an inner periphery of the second portion;
a support ring having a second inclined surface defined in an outer periphery thereof, the support ring located in a space enclosed by the first race;
a roller set having a plurality of rollers rotatably connected with a retaining frame, the rollers being located at an angle relative to a horizontal plane, the roller set located between the first race and the support ring, the rollers being in contact with the first and second inclined surfaces, and a second race having an L-shaped cross section and including a horizontal flange and a vertical flange which is engaged with the annular engaging recess and a noise absorbing material coated on an outer periphery of each of the horizontal flange and the vertical flange of the second race.

2. The bearing device as claimed in claim 1, wherein an annular lip extends inward from a lower end of the second portion and is engaged with an underside of the horizontal flange of the second race.

3. The bearing device as claimed in claim 1, wherein the first portion has an inclined outer periphery.

4. The bearing device as claimed in claim 1, wherein the support ring includes an annular notch defined in an inner periphery thereof and an inner periphery of the horizontal flange of the second race is engaged with the annular notch.
